(19) United States
(12) Patent Application Publication
(10) Pub. No.: US 2011/0155257 A1
(43) Pub. Date: Jun. 30, 2011

(54) METHOD AND ARRANGEMENT IN A PNEUMATIC MATERIAL CONVEYING SYSTEM

(75) Inventor: Göran Sundholm, Tuusula (FI)

(73) Assignee: MARICAP OY, Vantaa (FI)

(21) Appl. No.: 13/062,974

(22) PCT Filed: Sep. 2, 2009
(86) PCT No.: PCT/FI2009/050695

§ 371 Date: Mar. 9, 2011

(30) Foreign Application Priority Data
Sep. 10, 2008 (FI) 20085852

(51) Int. Cl. B65G 51/02; B65G 53/04

(52) U.S. Cl. 137/15.01; 137/238

(57) ABSTRACT

A method for draining the tank space (20) of a supply tank or feed chute in a pneumatic material conveying system, such as a waste conveying system, of material, such as waste material, in which method the tank space (20) is drained to a conveyor pipe (3) by opening an outlet valve (4), so that the underpressure prevailing in the conveyor pipe, together with the ambient pressure prevailing in the supply tank transfers material from the supply tank to the conveyor pipe (3). In the method, in the supply tank, a wall element (6) positioned at a distance from the outlet aperture (8) of the supply tank and/or from the outlet valve (4), which wall element (6) is arranged to move between at least two positions, i.e. a first position, where the wall element (6) restricts the access of material to the vicinity of the supply tank outlet aperture (8), and a second position, where the wall element (6) does not essentially restrict the access of material to the vicinity of the supply tank outlet aperture (8), is shifted from the first position to the second position. The invention also relates to an arrangement.

### BACKGROUND OF INVENTION

The invention relates to a method according to the preamble of claim 1.

The invention also relates to an arrangement according to claim 13.

The invention relates generally to pneumatic conveying systems, such as vacuum conveying systems, particularly to collecting and conveying waste, for instance household waste.

There are known systems where waste is conveyed in a piping by means of suction. In these, waste is conveyed by suction for long distances in the piping. Typical for them is that a vacuum apparatus is used for achieving a pressure difference, in which apparatus underpressure in the conveyor pipe is provided with vacuum generators, such as vacuum pumps or ejector equipment. In the conveyor pipe, there is typically arranged at least one valve element, and by opening and closing said valve element, make-up air coming in the conveyor pipe is regulated. In the systems, at the material feed end there are used supply tanks or feed chutes, where material, such as waste material, is fed, and from where the material to be conveyed is transferred either directly or by intermediation of a feed chute to a conveyor pipe by opening an outlet valve element, so that by means of a suction effect created by underpressure prevailing in the conveyor pipe and by the ambient air pressure effective through the tank, there is conveyed material, such as waste material packed in bags, from the supply tank or feed chute to a conveyor pipe. Now typically part of the makeup air required for feeding material has entered via the supply tank to a conveyor pipe, in which case it pulls along the material to be conveyed from the supply tank to the conveyor pipe.

However, in supply tanks or feed chutes the material to be fed is sometimes packed on the bottom of the tank, in the vicinity of the outlet aperture of the supply tank or the feed chute. When the connection from the supply tank to the conveyor pipe is opened, the material packed in the vicinity of the outlet aperture may block the outlet aperture or prevent the access of makeup air from the supply tank to a conveyor pipe. On the other hand, the material packed on the bottom of the feed chute, for example waste material packed in bags, requires a strong power for moving it and thus effective vacuum generators in the conveyor pipe. This in turn increases the energy consumption in the system. A feed chute arrangement according to the prior art is described in the publication WO 2002/102686. In this publication, the outlet valve is of the separate type and arranged as supported against the lower portion of the two-part insertion chute. The material fed in the insertion chute is pressed in the lower portion of the insertion chute and against the valve. The tightly packed waste material may in part obstruct the opening of the valve. On the other hand, it may become difficult to set the supplied material in motion at the lower portion of the feed chute.

The object of the present invention is to realize a completely novel arrangement to be applied in connection with the supply tank or feed chute of material conveying systems, by means of which arrangement the drawbacks of known solutions can be avoided.

### BRIEF DESCRIPTION OF INVENTION

The method according to the invention is mainly characterized in that in the method, in the supply tank, a wall element positioned at a distance from the outlet aperture of the supply tank and/or from the outlet valve, which wall element is arranged to move between at least two positions, i.e. a first position, where the wall element restricts the access of material to the vicinity of the supply tank outlet aperture, and a second position, where the wall element does not essentially restrict the access of material to the vicinity of the supply tank outlet aperture, is shifted from the first position to the second position. Moreover, the method according to the invention is characterized by what is set forth in claims 2-12.

The arrangement according to the invention is mainly characterized in that in the supply tank, at a distance from the outlet aperture of the supply tank and/or from the outlet valve, there is positioned a wall element, which wall element is arranged to move between at least two positions, i.e. a first position, where the wall element restricts the access of material to the vicinity of the supply tank outlet aperture, and a second position, where the wall element does not essentially restrict the access of material to the vicinity of the supply tank outlet aperture, and in that the arrangement comprises means for moving the wall element from the first position to the second position.

Moreover, the arrangement according to the invention is characterized by what is set forth in claims 14-24.

The solution according to the invention has several remarkable advantages. By means of the invention, there is achieved a fast and effective draining of the supply tank to a conveyor pipe. By means of the method and arrangement according to the invention, makeup air can be advantageously conducted in the vicinity of the outlet aperture, so that it affects the material, such as waste material, as effectively as possible. At the same time, however, the blocking of the supply tank outlet aperture can be avoided, which means that the functions of the material conveying system continue in good order. By conducting the material by means of a wall element that can be shifted between a first position and a second position, there is achieved an efficient, simple and functional structure for realizing the method. When the material is conducted on an inclined bottom part towards the outlet aperture, it is easier to set the material in motion, and thus the energy demand in the arrangement can in part be reduced. When the wall element is arranged as a pipe element, there is achieved an efficient arrangement, particularly as a wall element to be used in connection with the feed chute. By arranging the wall element actuators to be used in connection with the outlet valve actuators, there is achieved a cost-effective solution. When separate actuators are provided for the wall element, there are obtained more versatile possibilities for moving the wall element, at least with respect to opening and closing the outlet valve. By opening the outlet valve before the wall element is shifted from the first position to the second position, there is created a powerful flow to a conveyor pipe, so that the shifting of the wall element releases material to a conveying flow. This serves as a propelling force when setting the conveyed material in motion. By feeding the makeup air particularly in the portion left between the lower part of the wall element and the outlet aperture, there is achieved a good boost effect in the material to be conveyed. According to the invention, there can be used material supply tanks, which are the feed points of waste material, such as waste bins or refuse chutes. The method and arrangement according to the invention are particularly well suited to be used in connection with systems for conveying waste material, such as waste material arranged in bags.

### BRIEF DESCRIPTION OF DRAWINGS

In the description below, the invention is explained in more detail with reference to the appended drawings, wherein

FIG. 1 is a simplified illustration of a device according to an embodiment of the invention, viewed in partial cross-section, in the first position of the wall element and the outlet valve,

FIG. 2 is a simplified illustration of a device according to an embodiment of the invention, viewed in partial cross-section, between the first and second positions of the wall element and the outlet valve,

FIG. 3 is a simplified illustration of a device according to an embodiment of the invention, viewed in partial cross-section, in the second position of the wall element and the outlet valve,

FIG. 4 illustrates a device according to another embodiment of the invention, viewed in the first position of the wall element and in the second position of the outlet valve, and

FIG. 5 illustrates a device according to an embodiment of the invention, viewed in perspective and in partial cross-section, in the second position of the wall element and the outlet valve.

### DETAILED DESCRIPTION OF INVENTION

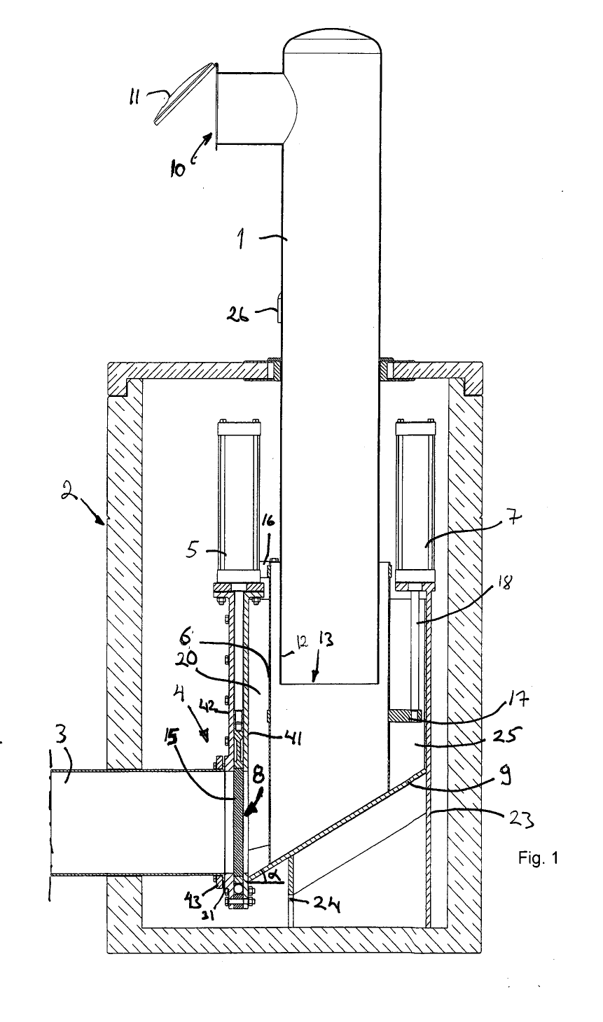

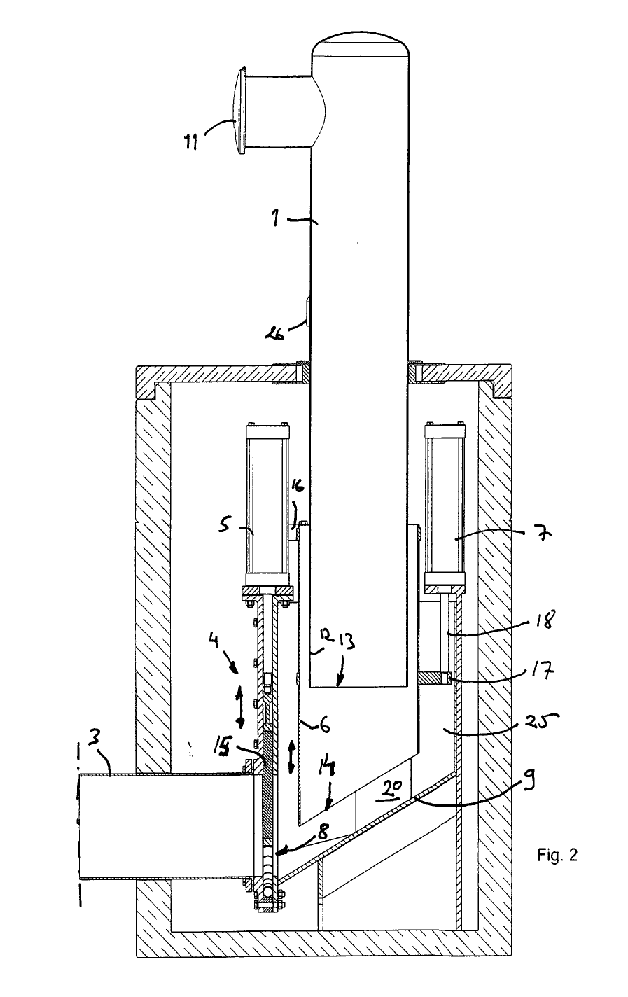

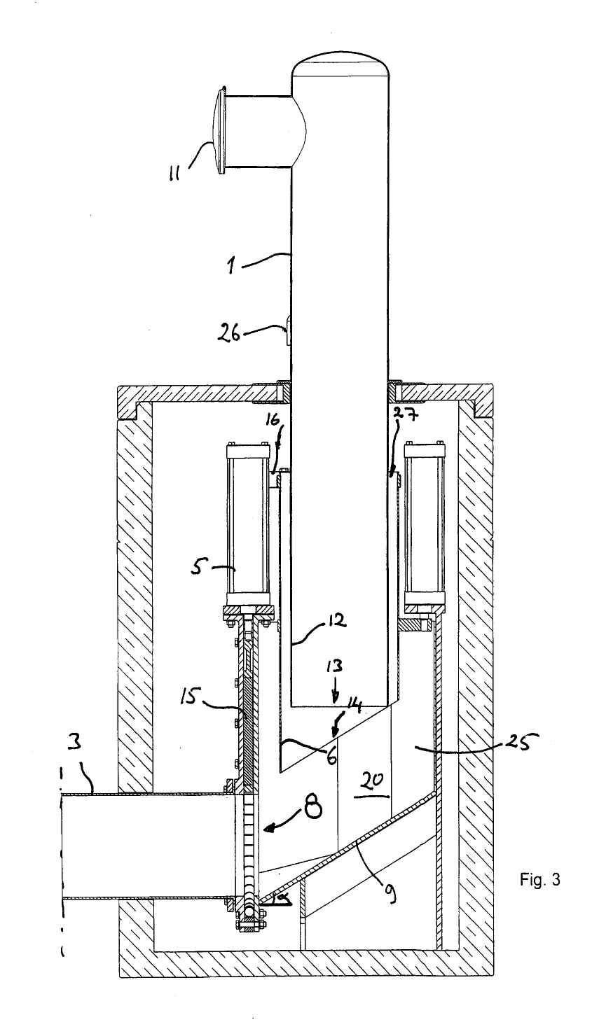

FIGS. 1-3 and 5 illustrate a first embodiment of a supply tank 2 connected to the feed chute 1 in a material conveying system according to the invention. The supply tank 2 comprises a material space 20, which is connected to a conveyor pipe 3. In between the conveyor pipe 3 and the material space 20 of the supply tank 2, there is an outlet valve 4, which is driven by an actuator 5. The material space 20 of the supply tank is defined by walls 25. At least one feed chute 1 is provided in the material space via the upper portion of the material space 20, through which chute, material is conducted to the material space. In the feed chute, there is arranged at least one feed aperture 10, through which material is fed to the feed chute. In the embodiment illustrated in the drawings, a hatch 11 is provided in connection with the feed aperture. In the lower portion of the material space 20 of the supply tank 2, there is an outlet 8, through which material is transferred from the supply tank to the conveyor pipe 3. In between the outlet aperture 8 and the conveyor pipe 3, there is arranged an outlet valve 4. The gate element 15 of the outlet valve has at least two positions, i.e. a first position or closed position, where the connection from the material space 20 to the conveyor pipe 3 is closed, and a second position or open position, where the connection from the material space 20 to the conveyor pipe 3 is open. In the embodiment illustrated in the drawings, the outlet valve is a gate valve. The gate element 15 is arranged to be movable in the space left between the walls 41, 42 of the gate valve body by means of an actuator 5. The side wall of the gate valve body is in the embodiment illustrated in the drawings arranged to form part of the wall of the material space 20. The drain pipe 3 is in the embodiment illustrated in the drawings fitted by a joint, preferably a flange joint 31, 43, in the wall 42 of the outlet valve body. That end of the drain pipe that is located on the side of the material space is provided with a collar 31, which is placed in between the flange 43 and the wall 42, and the flange 43 is secured, by fastening elements, against the collar 31.

In the supply tank, there is arranged, at a distance from the outlet aperture 8 of the supply tank and/or from the valve element 4 provided in between the conveyor pipe 3 and the outlet aperture 8, a wall element 6, which is arranged to move between at least two positions, i.e. a first position, where the wall element 6 restricts the access of material to the vicinity of the outlet aperture 8 of the material space 20 of the supply tank, and a second position, where the wall element 6 does not essentially restrict the access of material to the vicinity of the supply tank outlet aperture 8. The wall element 6 is advantageously a pipe element. The invention further comprises means for moving the wall element 6 between the first position and the second position.

In the material space 20 of the supply tank, there also is provided a bottom element 9, which is arranged to guide the material towards the outlet aperture 8 of the supply tank. The bottom element 9 of the supply tank is inclined. The bottom element 9 slopes towards the outlet aperture 8. The bottom element is inclined at an angle α (alfa) with respect to the horizontal plane.

In the embodiment of FIG. 1, the outlet valve 4 is illustrated in the closed position, in which case the connection from the material space 20 to the conveyor pipe 3 is closed.

Material is fed in the material space through a feed chute 1. In connection with the feed aperture 10 of the feed chute, there can be installed a hatch arrangement 11. The material is conveyed along the feed chute, owing to the effect of gravity, to be packed in the material space 20 against the lower portion walls and against the valve 4 of the outlet aperture 8, in which case in a conventional arrangement, there is the risk that the outlet aperture of the supply tank is blocked, and in pneumatic systems the risk that the access of makeup air, which is essential for the operation in the draining step, is prevented. Consequently, in the supply tank according to the invention, there is arranged a movable wall element 6. The wall element 6 defines the material space 20 at the lower part thereof.

A device according to the drawing functions as follows. When the material accumulated in the bottom part of the tank, such as garbage bags, should be discharged, the outlet valve 4 is opened, so that the underpressure prevailing in the conveyor pipe begins to affect in the vicinity of the outlet aperture 8, and makeup air flows through a makeup air pipe 26 along a medium path 27 to the vicinity of the outlet aperture. When the wall element 6 is shifted from the first position to the second position, the material has access to proceed towards the outlet aperture, and on the other hand, suction and makeup air affect the material located in the vicinity of the feed aperture 8, such as garbage bags, so that they are transferred in a desired way to a conveyor pipe 3. When the draining of the material to the conveyor pipe has ended, the outlet valve 4 is closed, and the wall element 6 can be shifted to the first position.

Thus the invention relates to a method for draining the tank space 20 of a supply tank or feed chute in a pneumatic material conveying system, such as a waste conveying system, of material, such as waste material, in which method the tank space 20 is drained to a conveyor pipe 3 by opening the outlet valve 4, so that by the underpressure prevailing in the conveyor pipe, together with the ambient pressure prevailing in the supply tank, material is transferred from the supply tank to the conveyor pipe 3. In the method, a wall element fitted in the supply tank, at a distance from the outlet aperture 8 of the supply tank, and/or from the outlet valve 4, which wall element is arranged to move between at least two positions, i.e. a first position, where the wall element 6 restricts the access of material to the vicinity of the outlet aperture 8 of the supply tank, and a second position, where the wall element 6 does not essentially restrict the access of material to the vicinity of the outlet aperture 8 of the supply tank, is shifted from the first position to the second position.

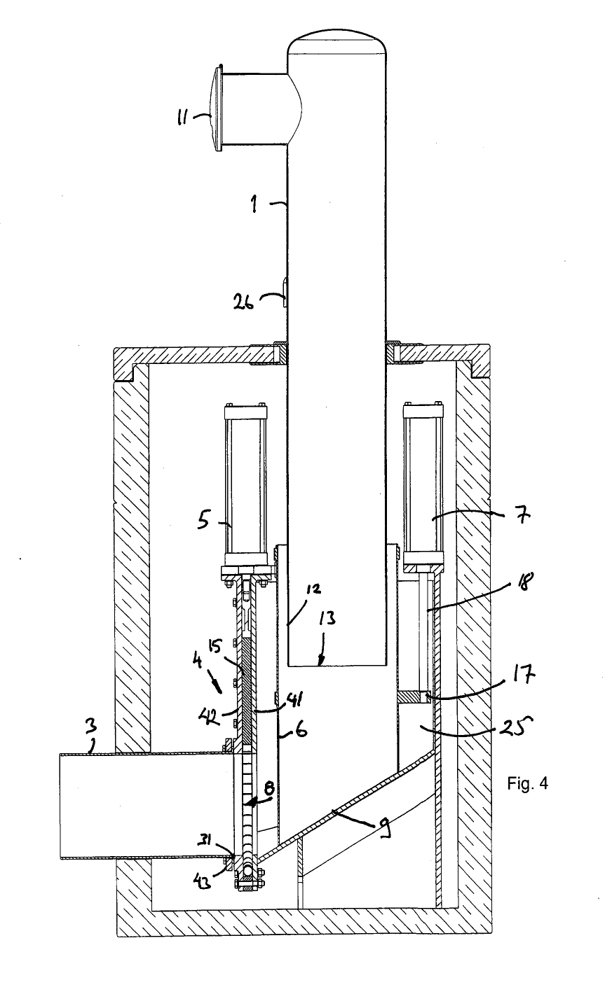

The method has alternative embodiments that can be applied according to the needs of each target of usage. According to a first embodiment, the wall element 6 is shifted from the first position to a second position prior to opening the outlet valve 4. The shifting of the wall element 6, i.e. the lifting of the tubular wall element 6 according to the embodiments illustrated in the drawings, from the low position to the high position can be performed immediately before opening the outlet valve. According to another embodiment, the wall element 6 is shifted from the first position to the second position after opening the outlet valve 4 (FIG. 4). Now the suction effect required for the conveying is already effective in the tank space, and the material has a rapid start to get moving.

According to a third embodiment, the wall element 6 is shifted from the first position to the second position at the same time as the outlet valve 4 is opened. Now the valve actuators can also be utilized for shifting the wall element. By using for instance connecting elements 16, 19, 21, the motion generated by the actuator 5 can be connected to the wall element.

According to a preferred embodiment, the material in the tank space 20 is guided towards the outlet aperture 8. Now there is achieved an effective transfer of the material from the tank space 20 to the conveyor pipe. By using an inclined bottom element 9, there is obtained an effective start for the material, as the own mass of the conveyed material can be made use of.

According to a preferred embodiment, the wall element 6 is a pipe element. In the embodiments of the drawings, the pipe element 6 is at least partly fitted around the lower portion of the feed chute 1. The material to be supplied is conducted in that part of the material space 20 that is defined by the wall element 6 and the bottom element 9. According to a preferred embodiment, the material space 20 is somewhat larger than the part of said space defined by the wall element 6.

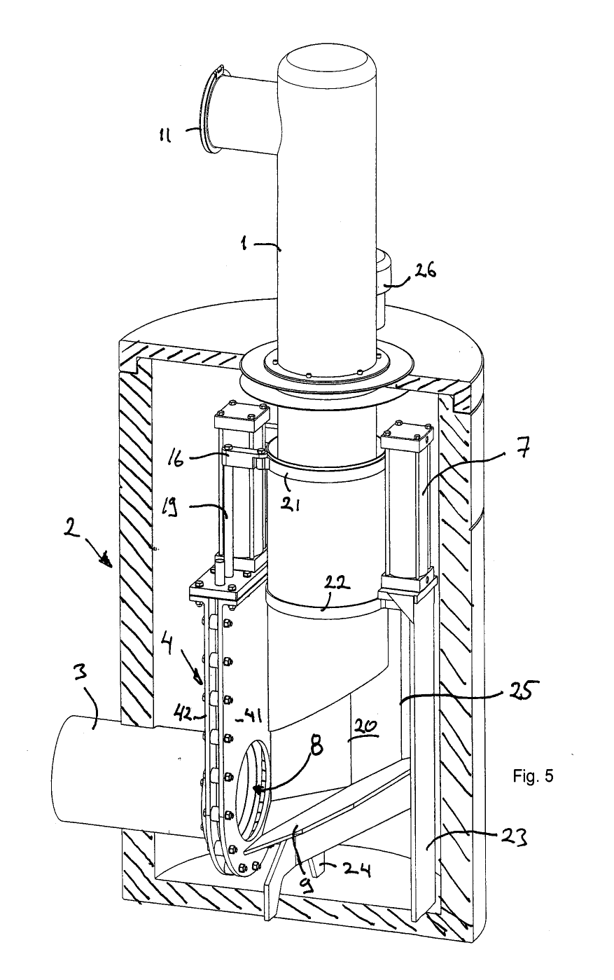

According to a preferred embodiment of the invention, the wall element 6 is manipulated by the actuator 5 of the outlet valve 4. Now the wall element 6 is shifted by the actuator 5 of the outlet valve between the first position and the second position. The arrangement comprises connecting means 16, 19 for connecting the wall element to an actuator. According to the embodiment of FIG. 5, the actuator moves the valve gate element 15, to which there is connected a rod element 16, which is further connected to a connecting element 16, which is yet further connected to the counterpart 21 of the wall element 6. Now the wall element 6 moves according to the movements of the valve gate element. According to the drawings, in connection with the wall element, there can be provided a control unit or guide elements that ensure a controlled motion for the wall element. According to FIG. 5, the second actuator 7 ensures a smooth motion for the wall element 6.

According to another embodiment, the wall element 6 is moved by means of its own moving devices 7, 17, 18. Now the wall element can be moved between the first and the second position, independently of the movements of the gate element of the outlet valve 4. FIG. 4 illustrates an embodiment where the actuator of the wall element 6 is a cylinder-piston combination, where the piston rod 18 is connected to a connecting element 17 by intermediation of the wall element 6.

In the embodiment according to the drawings, the wall element 6 is moved in the direction of the feed chute 1.

According to an embodiment of the invention, the material is guided, at least in the draining step, towards the outlet aperture 8 by means of an inclined bottom element 8.

In a typical embodiment, the material is waste material, particularly waste material arranged in bags.

The invention also relates to an arrangement for draining the tank space 20 of a supply tank or feed chute in a pneumatic material conveying system, such as a waste conveying system, of material, such as waste material, to a conveyor pipe 3, the tank space 20 of which comprises at least one feed aperture for feeding material in the tank space 20 and at least one outlet aperture 8 for draining the tank space to a conveyor pipe 3, as well as an outlet valve 4, arranged in between the conveyor pipe and the tank space, for adjusting the access of material from the material container via the outlet aperture to the conveyor pipe, so that the underpressure prevailing in the conveyor pipe 3 during the draining step is, together with the ambient pressure effective in the supply tank 20, arranged to convey material from the supply tank to the conveyor pipe 3. In the supply tank 20, at a distance from the outlet aperture 8 of the supply tank and/or from the outlet valve 4, there is provided a wall element 6, which is arranged to move between at least two positions, i.e. a first position, where the wall element 6 restricts the access of material to the vicinity of the supply tank outlet aperture 8, and a second position, where the wall element 6 does not essentially restrict the access of material to the vicinity of the supply tank outlet aperture 8; moreover, said arrangement comprises means for moving the wall element between the first and second positions.

According to a preferred embodiment, the wall element 6 is a pipe element. When the wall element is a pipe element, the shape of its cross-section can be similar to that of the feed chute, or it can have some other shape. Typically the wall element 6 is at least partly fitted around the lower portion 12 of the feed chute. In the embodiments according to the drawings, the walls of the feed chute 1 and the wall element 6 are spaced apart.

According to the invention, material is guided in the tank space 20 towards the outlet aperture.

According to a preferred embodiment, the means for moving the wall element 6 comprise an actuator 5 of the outlet valve 4.

According to a preferred embodiment, the means for moving the wall element 6 comprise a piston-cylinder combination 7, 17, 18, which at one end is arranged in a support element 23 that is immobile with respect to the wall element 6, and at the other end in the wall element 6.

According to a preferred embodiment, the wall element 6 is arranged to be moved in the direction of the feed chute 1. In the embodiment illustrated in the drawings, the wall element 6 is moved vertically. According to a typical embodiment, the wall element 6 is at least partly fitted around the lower portion 12 of the feed chute 1. In the embodiment illustrated in the drawings, the wall element is a channel element, particularly a pipe element, which is fitted around the feed chute element 1 that has a smaller diameter, so that the feed chute remains inside the periphery of the circle formed by the wall of the wall element.

According to a preferred embodiment, the tank space 20 of the supply tank comprises a bottom element 9, which is arranged to guide the material towards the outlet aperture 8 of the supply tank.

According to a typical embodiment, the bottom element 9 of the tank space 20 in the supply tank is inclined, so that the bottom element slopes towards the outlet aperture 8. Typically the material to be fed is conducted to that portion of the material space 20 that is defined by the wall element 6 and the bottom element 9. When the wall element is shifted from the first position to the second position, the material contained in said portion of the material space 20 is conveyed towards the outlet aperture. If the outlet valve 4 is open, the conveyor pipe is subjected to suction, in which case the pressure difference transfers the material, together with the effects of the inclined bottom element and gravity, from the material space to the conveyor pipe 3. In the first position, the lower part of the wall element 6 is fitted against the bottom element 9. In the second position, the lower part of the wall is spaced apart from the bottom element at a distance that enables the transfer of the material from the material space 20 to the conveyor pipe 3.

According to a preferred embodiment, the wall 41 of the body of the outlet valve 4 forms part of the wall of the tank space 20. The outlet valve can be provided with means for cleaning the space left between the valve walls 41, 42 by spraying a medium therein. Now the outlet valve 4 is provided with means for conducting a pressure medium into the space left in between the valve walls. Thus the valve can be maintained fully operational and sufficiently leak-proof.

For a man skilled in the art, it is obvious that the invention is not restricted to the above described embodiments only, but many modifications are possible within the scope of the appended claims. Such characterizing features that in the specification are possibly described together with other characterizing features can, when necessary, also be used separately.

1. A method for draining the tank space (20) of a supply tank or feed chute in a pneumatic material conveying system, such as a waste conveying system, of material, such as waste material, in which method the tank space (20) is drained to a conveyor pipe (3) by opening an outlet valve (4), so that the underpressure prevailing in the conveyor pipe, together with the ambient pressure prevailing in the supply tank transfers material from the supply tank to the conveyor pipe (3), characterized in that in the method, in the supply tank, a wall element (6) positioned at a distance from the outlet aperture (8) of the supply tank and/or from the outlet valve (4), which wall element (6) is arranged to move between at least two positions, i.e. a first position, where the wall element (6) restricts the access of material to the vicinity of the supply tank outlet aperture (8), and a second position, where the wall element (6) does not essentially restrict the access of material to the vicinity of the supply tank outlet aperture (8), is shifted from the first position to the second position.

2. A method according to claim 1, characterized in that the wall element (6) is shifted from the first position to the second position prior to opening the outlet valve (4).

3. A method according to claim 1, characterized in that the wall element (6) is shifted from the first position to the second position after opening the outlet valve (4).

4. A method according to claim 1, characterized in that the wall element (6) is shifted from the first position to the second position at the same time as the outlet valve (4) is opened.

5. A method according to claim 1, characterized in that material is guided in the tank space (20) towards the outlet aperture.

6. A method according to claim 1, characterized in that the wall element (6) is a pipe element.

7. A method according to claim 1, characterized in that the material to be supplied is conveyed to a material space (20) defined by the wall element (6) and the bottom element (9).

8. A method according to claim 1, characterized in that the wall element (6) is moved by the actuator (5) of the outlet valve (4).

9. A method according to claim 1, characterized in that the wall element (6) is moved by moving devices (7, 17, 18).

10. A method according to claim 1, characterized in that the wall element (6) is moved in the direction of the feed chute (1).

11. A method according to claim 1, characterized in that the material is conducted at least in the draining step towards the outlet aperture (8).

12. A method according to claim 1, characterized in that the material is waste material, particularly waste material arranged in bags.

13. An arrangement for draining the tank space (20) of a supply tank or feed chute in a pneumatic material conveying system, such as a waste conveying system, of material, such as waste material, to a conveyor pipe (3); said tank space (20) comprising at least one feed aperture for feeding material to the tank space (20), and at least one outlet aperture (8) for draining the tank space to a conveyor pipe (3), as well as an outlet valve (4) provided between the conveyor pipe and the tank space, by means of which the access of material through the material container outlet aperture to the conveyor pipe is adjusted, so that the underpressure prevailing in the draining step in the conveyor pipe (3) is, together with the ambient pressure prevailing in the supply tank (20), arranged to convey material from the supply tank to the conveyor pipe (3), characterized in that in the supply tank (20), at a distance from the outlet aperture (8) of the supply tank and/or from the outlet valve (4), there is provided a wall element (6), which is arranged to move between two positions, i.e. a first position, where the wall element (6) restricts the access of material to the vicinity of the supply tank outlet aperture (8), and a second position, where the wall element (6) does not essentially restrict the access of material to the vicinity of the supply tank outlet aperture (8), and that the arrangement comprises means for moving the wall element between the first and the second position.

14. An arrangement according to claim 13, characterized in that the wall element (6) is a pipe element.

15. An arrangement according to claim 13, characterized in that the material is conducted in the tank space (20) towards the outlet aperture.

16. An arrangement according to claim 13, characterized in that the means for moving the wall element comprise the actuator (5) of an outlet valve (4).

17. An arrangement according to claim 13, characterized in that the means for moving the wall element (6) comprise a piston-cylinder combination (7, 17, 18), which at one end is arranged in a support element that is immobile with respect to the wall element, and at the other end in the wall element.

18. An arrangement according to claim 13, characterized in that the wall element (6) is arranged to be moved in the direction of the feed chute (1).

19. An arrangement according to claim 13, characterized in that the wall element (6) is at least partly fitted around the lower portion (12) of the feed chute (1).

20. An arrangement according to claim 13, characterized in that the tank space (20) of the supply tank comprises a bottom element (9), which is arranged to guide the material towards the supply tank outlet aperture (8).

21. An arrangement according to claim 13, characterized in that the bottom element (9) of the tank space (20) of the supply tank is inclined, so that the bottom element slopes towards the outlet aperture (8).

22. An arrangement according to claim 13, characterized in that the wall (41) of the body of the outlet valve (4) forms part of the wall of the tank space (20).

23. An arrangement according to claim 13, characterized in that the lower part of the wall element (6) is in the first position fitted against the bottom element (9).

24. An arrangement according to claim 13, characterized in that the outlet valve (4) is also provided with means for spraying a medium in the space left between the walls (41, 42) of the body.
